(19) United States
(12) Patent Application Publication
(10) Pub. No.: US 2012/0313013 A1
(43) Pub. Date: Dec. 13, 2012

(54) SCINTILLATOR PLATE

(76) Inventors: Manfred Fuchs, Nuernberg (DE); Martina Hausen, Erlangen (DE)

(21) Appl. No.: 13/491,862

(22) Filed: Jun. 8, 2012

(30) Foreign Application Priority Data
Jun. 10, 2011 (DE) 102011077401.7

(51) Int. Cl. G01T 1/20

(52) U.S. Cl. 250/483.1

(57) ABSTRACT

A scintillator plate has a radiation-permeable substrate on which is applied a scintillator layer made of copper iodide that is formed from spicular crystals. The scintillator layer has an emission maximum in the red spectral range. The scintillator layer of the scintillator plate has a high emission power in the near-infrared range.

### BACKGROUND OF THE INVENTION

1. Field of the Invention

The invention concerns a scintillator plate with a radiation-permeable substrate on which is applied a scintillator layer formed from spicular (needle-shaped) crystals.

2. Description of the Prior Art

A scintillator plate of the above type is used, for example, in a digital x-ray detector (flat panel detector) in combination with an active matrix (two-dimensional, pixelated photosensor) that is subdivided into a plurality of pixel readout units with photosensors. The incident x-ray radiation is initially converted in the scintillator layer of the scintillator plate into visible light that is subsequently transduced by the photosensors into electrical charge and is stored with spatial resolution. This conversion (known as an indirect conversion) is described in the article by M. Spahn et al. “Flachbilddetektoren in der Röntgendiagnostik” [“Flat panel detectors in x-ray diagnostics”] in “Der Radiologe [The Radiologist] 43 (2003)”, Pages 340 to 350, for example.

Typical scintillator layers have CsI:TI (thallium-doped cesium iodide), CsI:Na (sodium-doped cesium iodide), NaI:TI (thallium-doped sodium iodide), CuI (copper iodide) or similar materials that include alkali halogenides. CsI is hereby particularly well suited as a scintillator material since it can be applied in the form of needles. In spite of a high layer thickness that ensures an optimal absorption of the x-ray radiation, a good spatial resolution of the x-ray image is achieved via the spicular structure of the cesium iodide. The good spatial resolution results from what is known as the “optical waveguide” effect, which is achieved due to the air gaps between the scintillator needles.

A scintillator plate with a radiation-permeable substrate on which a scintillator layer formed from spicular crystals is applied is known from DE 10 220 009 700 A1. The scintillator layer comprises copper iodide, which possesses an emission wavelength in the blue spectral range.

A detector that has a storage luminophore is known from US 2010/0034351 A1. The storage luminophore comprises multiple components and is doped with at least one colorant (copper, for example). A targeted defect generation from undoped material is not described.

The known scintillator plates in which x-ray or gamma radiation is converted into light in the scintillator layers are used in medical imaging, in the inspection of freight and luggage and in non-destructive material inspection, for example. In addition to a high absorption for the incident x-ray or gamma radiation, the scintillator materials that are used for the scintillator layers should also have a high light yield. The generated light (for example green light given CsI:TI, blue light given NaI:TI) is then transduced into electrical signals with a photosensitive element, and an image of the exposed subject is generated from this. In addition to the high absorption and light yield, the optical adaptation between the emission wavelength (which is typically in the blue or green spectrum) and the wavelength-dependent sensitivity of the photosensitive element thus also plays a significant role. The degree of transduction between the detected light quanta into electrons is also a significant characteristic of the photosensitive element. CCDs, amorphous or crystalline silicon (Si) and CMOS are typically used as photosensitive elements. These photosensitive elements are spectrally adapted to sunlight (and thus to green-emitting luminophores) in terms of their sensitivity. Si photodiodes that are not spectrally adapted are also used for green-emitting scintillators in part. In general, it can be established that the sensitivity in the adapted spectral range is somewhat increased via the spectral adaptation of the photosensitive elements. However, non-adapted photodiodes have higher spectral sensitivities. The spectral sensitivity is thus highest in the near-infrared range (900 nm-920 nm) in non-adapted Si photodiodes.

### SUMMARY OF THE INVENTION

An object of the present invention is to provide a scintillator plate having a scintillator layer with a sufficiently high emission power.

The scintillator plate according to the invention has a radiation-permeable substrate on which is applied a scintillator layer of copper iodide (CuI) formed from spicular crystals. According to the invention, the scintillator layer has an emission maximum in the red spectral range.

The scintillator material (copper iodide) that is used for the scintillator layer in the scintillator plate according to the invention possesses a peak with a low intensity at 425 nm (blue spectrum) and a peak with a high intensity at 720 nm (red spectrum). The 720 nm peak (decay time is approximately 30 ms to approximately 40 ms) hereby has an approximately 7.5 times higher intensity than the 425 nm peak (decay time of approximately 100 ps).

The decrease of the intensity of the primary emission at approximately 425 nm and increase of the red emission at approximately 600 nm to 800 nm arises as a result of the addition of iodine defects.

The copper iodide used in the invention thus has its maximum emission power in the range from approximately 600 nm to approximately 800 nm. In this range the signal strength of a spectral non-adapted photodiode made of crystalline silicon amounts to approximately 0.40 A/W to approximately 0.55 A/W, wherein the maximum of the signal strength in the aforementioned silicon photodiode amounts to approximately 0.6 A/W given a wavelength of the incident light of approximately 950 nm.

In the production of the CuI scintillator layer for the scintillator plate according to the invention, powdered copper is added to the powdered copper iodide in a copper vaporizer. The copper iodide and the copper can also be present as a granulate instead of a powder.

The gaseous iodine reacts with the powdered copper iodide at a temperature of approximately 600 C to 650 C and a pressure of approximately 10⁻⁴ mbar to approximately 10⁻⁵ mbar, wherein the gaseous iodine partially decomposes. Gaseous copper (Cu), gaseous iodine (I) and gaseous copper iodide (CuI) form in the copper vaporizer, wherein the added copper powder reacts with the iodine (vaporous) released in the copper vaporizer to form copper iodide (vaporous).

The gaseous copper iodide and the gaseous iodine exit from the copper vaporizer and deposit as copper iodide on the substrate.

A thermal decomposition of the copper iodide and a discoloration (beige, yellow, brown) of the CuI scintillator layer applied on the substrate that results from this is prevented via the addition of copper powder to copper iodide.

A pronounced discoloration of the copper iodide can lead to a correspondingly reduced intensity and a correspondingly small light yield given an excitation by incident x-ray radiation. The measurements were implemented with a CCD camera in comparison to the scintillator material Gd₂O₂S:Tb (terbium-doped gadolinium oxysulfide).

First the admixing of CuI powder (or, respectively, granulate) with Cu powder (or, respectively, granulate) and the subsequent vaporization generates a nearly white CuI layer with a high light intensity. The higher the ratio between Cu powder and the admixed CuI powder, the whiter the CuI layer and the higher the 720 nm peak, wherein at the same time the 425 nm peak is lower. This can be pursued as necessary until the 425 nm peak disappears.

Due to the emission maximum at approximately 720 nm, photodiodes that have a higher sensitivity than the previously used photodiodes that are designed for sunlight can be used to detect the emission light generated in the scintillator.

### BRIEF DESCRIPTION OF THE DRAWINGS

FIG. 1 shows emission spectra of scintillator layers that are used in scintillator plates according to the prior art, in comparison to an emission spectrum of a scintillator layer made of copper iodide.

FIG. 2 shows the sensitivity of a silicon photodiode depending on the wavelength of the incident light.

### DESCRIPTION OF THE PREFERRED EMBODIMENTS

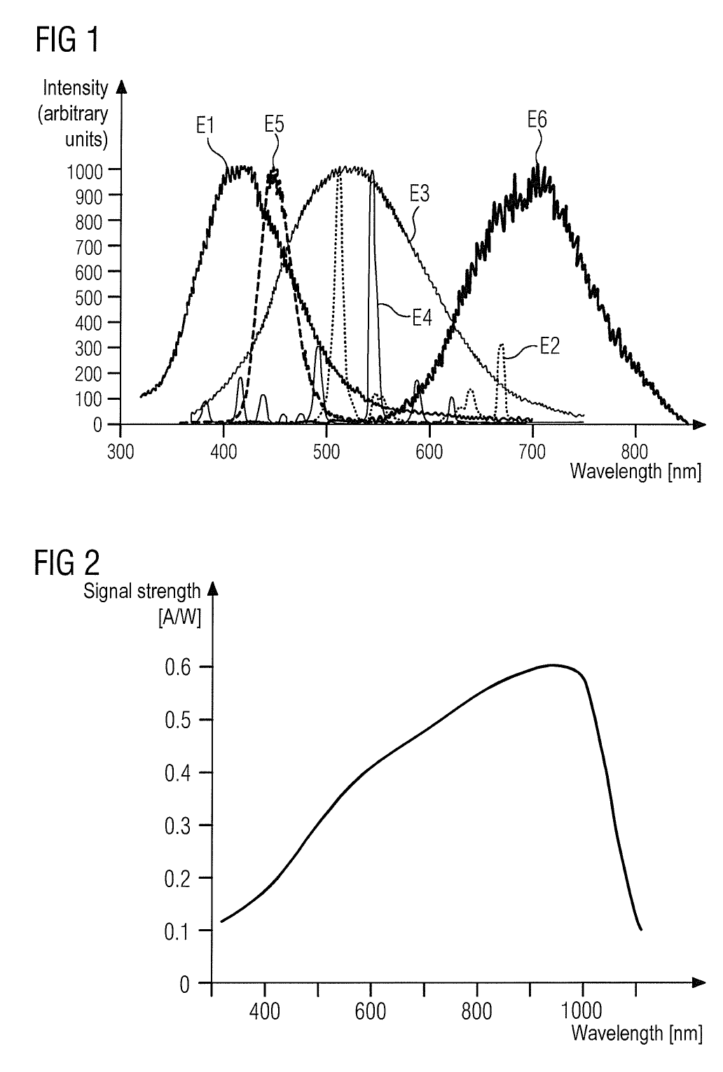

The emission spectra E1 through E4 of the following scintillator materials according to the prior art are shown in FIG. 1:

E1 CsI:Na (cesium iodide, doped with sodium) with an emission maximum at approximately 420 nm,

E2 Gd₂O₂S:Pr,Ce (gadolinium oxysulfide, doped with praseodymium and cerium) with an emission maximum at approximately 515 nm (UFC, Ultra Fast Ceramic),

E3 CsI:TI (cesium iodide, doped with thallium) with an emission maximum at approximately 525 nm,

E4 Gd₂O₂S:Tb (gadolinium oxysulfide, doped with terbium) with an emission maximum at approximately 545 nm.

Furthermore, the emission spectrum of a storage luminophore is shown for comparison:

E5 CsBr:Eu (cesium bromide, doped with europium) with an emission maximum at approximately 445 nm.

The emission spectrum of the scintillator material according to the invention is likewise shown:

E6 CuI (copper iodide with nearly white coloration) with an emission maximum at approximately 720 nm.

Scintillators (emission spectra E1 through E4) or storage luminophores (emission spectrum E5) that emit light in a blue spectral range or, respectively, in a green spectral range are typically used for the conversion of x-ray radiation into light.

For example, CCDs, aSi photodiodes and CMOS which are spectrally adapted to sunlight (and thus to green-emitting luminophores) in terms of their sensitivity are used as photosensitive elements. Si photodiodes that are not spectrally adapted are also used in part for green-emitting scintillators. In general, it can be noted that the sensitivity in the adapted spectral range is somewhat increased by the spectral adaptation of the photosensitive elements; however, the sensitivity of non-adapted Si photodiodes is highest in the near-infrared range (900 to 920 nm).

Due to the emission maximum at approximately 720 nm, photodiodes that have a higher sensitivity than the previously used photodiodes designed for sunlight can be used to detect the emission light generated in the scintillator. One example of the sensitivity of such a photodiode is shown in FIG. 2.

Copper iodide has its maximum emission power in a range from approximately 600 nm to approximately 800 nm. In this range the signal strength of the spectrally non-adapted photodiode made of crystalline silicon (shown in FIG. 2) amounts to approximately 0.40 A/W to approximately 0.55 A/W, wherein the maximum of the signal strength in the silicon photodiode shown in FIG. 2 amounts to approximately 0.6 A/W given a wavelength of the incident light of approximately 950 nm.

Although modifications and changes may be suggested by those skilled in the art, it is the intention of the inventors to embody within the patent warranted hereon all changes and modifications as reasonably and properly come within the scope of their contribution to the art.

We claim as our invention:

1. A scintillator plate comprising:
a radiation-permeable substrate;
a scintillator layer applied on said substrate, said scintillator layer comprising copper iodide spicular crystals; and
said scintillator layer having an emission maximum in the red spectral range.

2. A scintillator plate as claimed in claim 1 wherein said scintillator layer emits light quanta having a maximum intensity at 720 nm.

3. A scintillator plate as claimed in claim 1 wherein said scintillator layer is white.
